(19) United States
(12) Patent Application Publication
(10) Pub. No.: US 2026/0004448 A1
(43) Pub. Date: Jan. 1, 2026

(54) IMAGE PROCESSING DEVICE, IMAGE PROCESSING METHOD, AND IMAGE PROCESSING PROGRAM

(71) Applicant: NEC Corporation, Tokyo (JP)

(72) Inventor: Yoshikazu WATANABE, Tokyo (JP)

(73) Assignee: NEC Corporation, Tokyo (JP)

(21) Appl. No.: 19/234,396

(22) Filed: Jun. 11, 2025

(30) Foreign Application Priority Data
Jun. 26, 2024 (JP) 2024-102507

(51) Int. Cl. G06T 7/70; G06T 7/20

(52) U.S. Cl. CPC G06T 7/70; G06T 7/20; G06T 2207/10016

(57) ABSTRACT

An image processing device includes an object position prediction unit configured to predict a position of an object in a new input image based on a position of the object detected in a past input image, a second object detection unit configured to perform object detection within a partial region in the new input image, an object detection target region determination unit configured to determine an object detection target region to be an object detection target in the new input image based on a prediction result by the object position prediction unit and an object detection result by the second object detection unit, and a first object detection unit configured to perform object detection for the object detection target region determined by the object detection target region determination unit.

This application is based upon and claims the benefit of priority from the prior Japanese Patent Application No. 2024-102507, filed Jun. 26, 2024, the entire contents of which are incorporated herein by reference.

### BACKGROUND OF INVENTION

### Field of the Invention

The present disclosure relates to an image processing device, an image processing method, and an image processing program.

### Description of the Related Art

As a technique related to image processing, for example, Patent literature 1 discloses a technique related to object detection using a neural network.

[Patent literature 1] Japanese Patent Application Publication No. 2019-036008

### SUMMARY OF INVENTION

The object detection processing is required to have a high throughput. For example, a system that performs object detection processing on an image output from a monitoring camera needs to operate at a relatively high frame rate in order to prevent overlooking (that is, detection omission). However, in order to achieve a high throughput without suppressing the processing load of the object detection processing, problems such as an increase in the number of devices used for processing, an increase in cost, and an increase in power consumption occur.

The technique described in Patent literature 1 aims to improve the accuracy of detecting the position of an object by correcting information acquired in the process of estimation based on movement information of the object acquired from an image sequence. Therefore, in the technique described in Patent literature 1, an effect of suppressing the processing load of the object detection processing cannot be expected.

The present disclosure has been made in view of these problems. An object of the present disclosure is to provide an image processing device, an image processing method, and an image processing program capable of suppressing a processing load of object detection processing.

An image processing device according to the present disclosure includes an object position prediction unit configured to predict a position of an object in a new input image based on a position of the object detected in a past input image, a second object detection unit configured to perform object detection within a partial region in the new input image, an object detection target region determination unit configured to determine an object detection target region to be an object detection target in the new input image based on a prediction result by the object position prediction unit and an object detection result by the second object detection unit, and a first object detection unit configured to perform object detection for the object detection target region determined by the object detection target region determination unit.

An image processing method according to the present disclosure causes a computer to execute predicting a position of an object in a new input image based on a position of the object detected in a past input image, performing second object detection within a partial region in the new input image, determining an object detection target region to be an object detection target in the new input image based on a prediction result and a second object detection result, and performing first object detection within the object detection target region.

An image processing program according to the present disclosure causes a computer to execute predicting a position of an object in a new input image based on a position of the object detected in a past input image, performing second object detection within a partial region in the new input image, determining an object detection target region to be an object detection target in the new input image based on a prediction result and a second object detection result, and performing first object detection within the object detection target region.

According to the present disclosure, the processing load of the object detection processing can be suppressed.

### BRIEF DESCRIPTION OF THE DRAWINGS

FIG. 1 is a block diagram illustrating a functional configuration of an image processing device;

FIG. 2A to FIG. 2E are explanatory diagrams illustrating an operation outline of a second object detection unit;

FIG. 3 is a flowchart illustrating an operation of the image processing device;

FIG. 4 is a flowchart illustrating an operation of the image processing device;

FIG. 5 is a block diagram illustrating an example of a hardware configuration;

FIG. 6 is a block diagram illustrating a functional configuration of the image processing device;

FIG. 7 is a flowchart illustrating an operation of the image processing device; and

FIG. 8 is a block diagram illustrating a main part of the image processing device.

### DESCRIPTION OF THE PREFERRED EMBODIMENTS

Hereinafter, example embodiments of the present disclosure will be described with reference to the drawings. In the drawings, the same or relevant elements are denoted by the same reference numerals, and redundant description is omitted as necessary for clarity of description. Unless otherwise described, predetermined values such as predetermined values and thresholds are stored in advance in a storage device or the like accessible from a device using the values. Unless otherwise described, the storage unit includes one or more arbitrary number of storage devices.

### Example Embodiment 1

### Description of Configuration

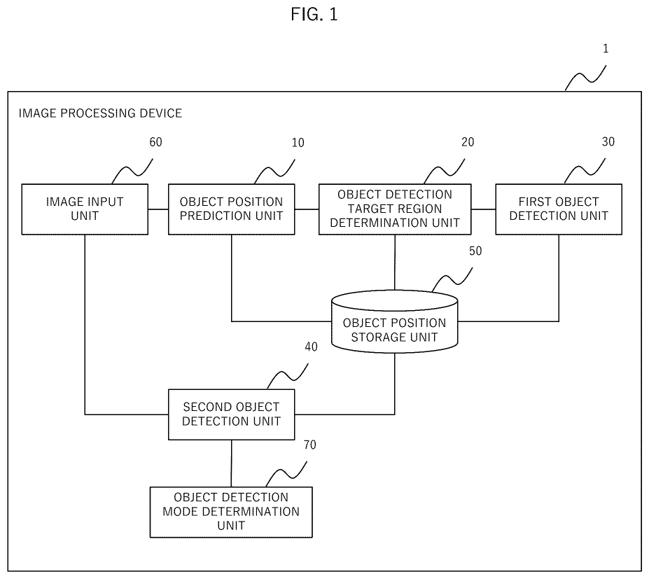

A functional configuration of an image processing device according to a first example embodiment will be described. FIG. 1 is a block diagram illustrating a functional configuration of the image processing device. An image processing device 1 illustrated in FIG. 1 includes an object position prediction unit 10, an object detection target region determination unit 20, a first object detection unit 30, a second object detection unit 40, an object position storage unit 50, an image input unit 60, and an object detection mode determination unit 70. The number of components and the connection relationship illustrated in FIG. 1 are an example. For example, the image processing device 1 may include a plurality of image input units 60.

The image processing device 1 may be configured using a computer device including a central processing unit (CPU), a main memory, and a secondary storage device. In this case, the object position prediction unit 10, the object detection target region determination unit 20, the first object detection unit 30, the second object detection unit 40, the object position storage unit 50, the image input unit 60, and the object detection mode determination unit 70 of the image processing device 1 illustrated in FIG. 1 are achieved by the CPU executing processing according to a program stored in the secondary storage device. The hardware configuration of the image processing device 1 will be further described later.

In the present example embodiment, an example in which the image processing device 1 uses an image as an input and detects a person in the image as an object will be described. For example, the image processing device 1 executes an object detection task of a person class. However, the object detection task that can be executed by the image processing device 1 is not limited to the person class. Hereinafter, the image input to the image processing device 1 is also referred to as an input image.

The object position prediction unit 10 predicts the position of the object in the newly input image based on the position of the object detected in the image input in the past. Hereinafter, an object detected by object detection from an image is also referred to as a known object.

The first object detection unit 30 detects an object of a known object in a newly input image. The second object detection unit 40 performs object detection for the purpose of preventing a new object from being overlooked in a newly input image. The new object is, for example, an object of which information indicating the past position is not stored in the object position storage unit 50. The new object is, for example, an object that is not sufficiently accumulated in the object position storage unit 50 to the extent that information indicating the past position is used as an input to prediction by the object position prediction unit 10. The operations of the object position prediction unit 10, the first object detection unit 30, and the second object detection unit 40 are not limited thereto.

The object position prediction unit 10 uses the position information indicating the past position of the object stored in the object position storage unit 50 as an input to prediction. The object position prediction unit 10 predicts the position of the object in the next image input from the image input unit 60 based on the position information. Hereinafter, the image input from the image input unit 60 is also referred to as an input image. The object position prediction unit 10 may use the position information of the object detected by the second object detection unit 40 as an input to prediction. An example in which the object position prediction unit 10 uses the position information of the object detected by the second object detection unit 40 as an input to prediction will be described later.

The object detection target region determination unit 20 uses the prediction result by the object position prediction unit 10, the past position information of the known object stored in the object position storage unit 50, and the information regarding the new object to determine the region in the input image where the first object detection unit 30 should execute the object detection processing. Hereinafter, a region to be subjected to the object detection processing by the first object detection unit 30 in the input image is also referred to as an object detection target region. The object detection target region is, for example, a set of partial regions that are a part of the entire input image region. Hereinafter, each partial region constituting the object detection target region is also referred to as an individual object detection target region. Details of the individual object detection target region will be described later.

The first object detection unit 30 executes an object detection task with an image as an input and outputs an object detection result. For example, the first object detection unit 30 uses, as an input, only a region including the position of the object predicted by the object position prediction unit 10 (or the individual object detection target region determined by the object detection target region determination unit 20) in the input image input from the image input unit 60. The first object detection unit 30 performs, for example, object detection processing using deep learning. The first object detection unit 30 holds a learned model. For example, the storage medium included in the first object detection unit 30 stores a learned model. The first object detection unit 30 applies the learned model to an input to perform inference. The first object detection unit 30 outputs a bounding box (BB), a class, a score, and the like for each object as the object detection result. However, the operation of the first object detection unit 30 is not limited thereto. For example, the first object detection unit 30 may hold a plurality of learned models. The first object detection unit 30 may switch parameters (for example, a learned model or an input size to be used) used for inference according to the characteristics (for example, the height and width of the region) of the individual object detection target region. For example, the first object detection unit 30 may perform inference using a smaller input size for an individual object detection target region having a small height and width.

The second object detection unit 40 executes an object detection task on the input image input from the image input unit 60. The second object detection unit 40 outputs an object detection result obtained by executing the object detection task. The second object detection unit 40 performs the object detection processing using deep learning, for example, similarly to the first object detection unit 30.

The second object detection unit 40 performs object detection within a partial region in the new input image. For example, the second object detection unit 40 divides the input image into a plurality of regions, and performs object detection by switching a target region for each input image.

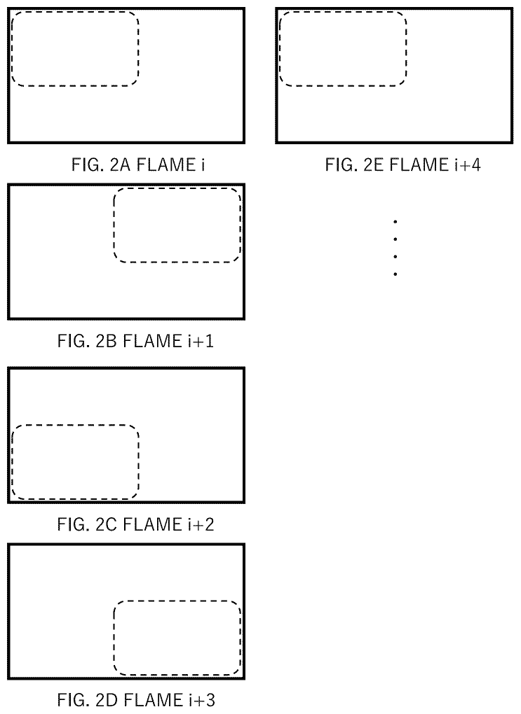

The operation of the second object detection unit 40 will be described. FIG. 2A to FIG. 2E are explanatory diagrams illustrating an operation outline of the second object detection unit. FIG. 2A to FIG. 2E are explanatory diagrams for facilitating understanding of the operation outline of the second object detection unit 40. Therefore, the operation of the second object detection unit 40 is not limited to that illustrated in FIG. 2A to FIG. 2E.

FIG. 2A to FIG. 2E illustrate images of frames continuously input as input images. FIG. 2A illustrates an image of a frame i. FIG. 2B illustrates an image of a frame i+1 input next to the frame i. FIG. 2C illustrates an image of a frame i+2 input next to the frame i+1. FIG. 2D illustrates an image of a frame i+3 input next to the frame i+2. FIG. 2E illustrates an image of a frame i+4 input next to the frame i+3.

FIG. 2A to FIG. 2E illustrate examples in which an input image is divided into four regions, and a target region is switched for each input image to perform object detection. Specifically, an example is illustrated in which the region of the input image is vertically divided into two regions and further horizontally divided into two regions to be divided into four regions. That is, FIG. 2A to FIG. 2E illustrate examples in which the input image is divided into four regions of an upper left region, an upper right region, a lower left region, and a lower right region.

In the examples illustrated in FIG. 2A to FIG. 2E, when the image of the frame i is input as the input image, the second object detection unit 40 performs object detection on the upper left region of the input image as a target as illustrated in FIG. 2A. Next, when the image of the frame i+1 is input as the input image, the second object detection unit 40 performs object detection on the upper right region of the input image as a target as illustrated in FIG. 2B. Next, when the image of the frame i+2 is input as the input image, the second object detection unit 40 performs object detection on the lower left region of the input image as a target as illustrated in FIG. 2C. Next, when the image of the frame i+3 is input as the input image, the second object detection unit 40 performs object detection on the lower right region of the input image as a target as illustrated in FIG. 2D. Next, when the image of the frame i+4 is input as the input image, the second object detection unit 40 performs object detection on the upper left region of the input image as a target as illustrated in FIG. 2E.

In this manner, the second object detection unit 40 divides the input image into a plurality of regions, and performs object detection by switching a target region for each input image. A method of dividing and switching the regions of the input image illustrated in FIG. 2A to FIG. 2E is one of methods applicable to the second object detection unit 40. The second object detection unit 40 can apply other various ways of dividing and switching the regions of the input image.

The second object detection unit 40 may divide the input image into a plurality of regions in a mode in which regions partially overlap each other. For example, it is assumed that the input image is divided into a first region and a second region, and the first region and the second region are switched for each input image to be the object detection target. In this case, the first region and the second region may partially overlap each other. The first region and the second region may not completely overlap each other.

The second object detection unit 40 can temporarily enlarge a region targeted for object detection. For example, when detecting a new object at the end of the region, the second object detection unit 40 temporarily enlarges the region adjacent to the end.

Specifically, it is assumed that the second object detection unit 40 performs object detection on the upper left region of the image of the frame i illustrated in FIG. 2A and detects a new object at the lower end of the upper left region. Alternatively, it is assumed that the second object detection unit 40 detects a part of the new object at the lower end of the upper left region. That is, it is assumed that the new object is predicted to be located at the boundary between the upper left region and the lower left region. In this case, when object detection is performed on the lower left region of the image of the frame i+2 illustrated in FIG. 2C, the second object detection unit 40 temporarily enlarges the lower left region so as to include the lower end of the upper left region. In this way, the second object detection unit 40 can suitably detect the new object according to the situation.

The second object detection unit 40 may use a learned model different from that of the first object detection unit 30. For example, the second object detection unit 40 may use a learned model that is lighter than the learned model used by the first object detection unit 30. By doing so, the image processing device 1 can suppress the processing load of the object detection processing.

The second object detection unit 40 may intermittently perform object detection on a plurality of input images continuously input from the image input unit 60. For example, the second object detection unit 40 may execute the object detection every predetermined period. For example, the second object detection unit 40 may execute the object detection for each predetermined number of frames.

For example, it is assumed that the second object detection unit 40 is configured to perform object detection every four frames. In this case, when the image of the frame i is input as the input image, the second object detection unit 40 performs object detection on the upper left region of the input image. Thereafter, the second object detection unit 40 does not perform the object detection even if the images of the frames i+1 to i+3 are sequentially input. Then, when the image of the frame i+4 is input as the input image, the second object detection unit 40 performs object detection on the upper right region of the input image. By doing so, the image processing device 1 can suppress the processing load of the object detection processing.

The object position storage unit 50 stores information regarding an object (known object) detected by the first object detection unit 30. The object position storage unit 50 stores information regarding an object (new object) detected by the second object detection unit 40. The object position storage unit 50 stores, for example, all or part of a bounding box, a class, a score, a time of detection, an identifier of an input image in which the object is detected, and an identifier of the image input unit 60 that has generated the input image, as the information regarding the object.

The image input unit 60 generates an image (that is, an input image) to be processed by the image processing device 1. The image input unit 60 may be achieved by, for example, a monitoring camera. For example, the image input unit 60 may directly use an image captured by the camera as an input image, or may use an image subjected to preprocessing such as image processing or clipping as an input image. The image input unit 60 may input, for example, each image continuously output at a predetermined frame rate from a device outside the image processing device 1 as an input image.

The object detection mode determination unit 70 determines an execution mode of object detection by the second object detection unit 40. For example, the object detection mode determination unit 70 determines the execution mode of the object detection by the second object detection unit 40 as the mode of the operation examples illustrated in FIG. 2A to FIG. 2E. The second object detection unit 40 performs object detection based on the determination result of the object detection mode determination unit 70.

The object detection mode determination unit 70 can also determine that the object detection is not performed as the execution mode of the object detection by the second object detection unit 40. In this case, the second object detection unit 40 does not perform the object detection based on the determination result of the object detection mode determination unit 70. Such a configuration is applied to, for example, a configuration in which the second object detection unit 40 intermittently executes object detection on a plurality of input images continuously input from the image input unit 60.

For example, the object detection mode determination unit 70 may determine the execution mode of the object detection by the second object detection unit 40 for the new input image based on the object detection result related to the past input image. Details of a case where the execution mode of the object detection is determined based on the object detection result related to the past input image will be described later.

Next, a method of predicting the object position by the object position prediction unit 10 will be described.

Methods for predicting a future position of an object from a past position have been widely studied. For example, there is a research field called human trajectory prediction regarding position prediction of a person. In recent years, a human trajectory prediction method using deep learning has been widely studied. In the human trajectory prediction method using deep learning, inference is performed by a learned model using a past movement trajectory as an input, and a future movement trajectory is predicted.

The object position prediction unit 10 can perform prediction processing of the object position using an arbitrary human trajectory prediction method. In many human trajectory prediction methods, information obtained by collecting movement trajectories of the same person is used as an input in order to obtain high prediction accuracy. In many human trajectory prediction methods, tracking processing of determining the same person from a plurality of images captured at different times in the past is performed in order to obtain information collecting movement trajectories of the same person. However, execution of the tracking processing involves a calculation load. Therefore, in a case where the human trajectory prediction method requiring the tracking processing is applied to the image processing device 1, there is a risk of causing an increase in processing load and a decrease in processing throughput.

The object position prediction unit 10 can use a prediction method that does not require tracking processing instead of a prediction method that requires tracking processing. Hereinafter, an example of a prediction method that does not require the tracking processing will be described. The object position prediction unit 10 of the present example embodiment uses a prediction method that does not require tracking processing described below. This prediction method is also referred to as a first prediction method of the present example embodiment. However, the prediction method that can be used by the object position prediction unit 10 is not limited to the first prediction method of the present example embodiment.

When position information of an object at a plurality of different times is used as an input to prediction, there is a case where tracking processing is executed and information obtained by collecting movement trajectories of the same person is used. In this case, the input to prediction is not independent among the plurality of times, and it can be said that there is a dependency relationship. On the other hand, there is a case where the tracking processing is not executed and only the position information of the object at each time is used as an input to prediction. In this case, it can be said that the inputs to prediction are independent from each other among the plurality of times. The first prediction method of the present example embodiment is a prediction method that does not execute tracking processing. Therefore, the first prediction method of the present example embodiment uses information independent from each other among a plurality of different times as an input to prediction.

The first prediction method of the present example embodiment uses position information of an object in an input image at a plurality of past times as an input. In the present example, the number of past (that is, observed) times is set as Nobs. The first prediction method of the present example embodiment predicts a position of an object in an input image at a next time. However, the prediction target of the first prediction method of the present example embodiment is not limited thereto. For example, the first prediction method of the present example embodiment may predict the position of the object in the input image at a plurality of future times. The number of objects included in the input image may be an arbitrary number.

In the first prediction method of the present example embodiment, the input image and the output image (that is, the prediction result) are divided into predetermined sizes, and the position of the object is managed in units of divided regions (grids). In the first prediction method of the present example embodiment, for example, in a case where the original image is full high definition (HD) [1920×1080] and a size of 32×32 is used as the predetermined size, 60×34 grids are used for management.

In the first prediction method of the present example embodiment, inference input data to be input to the learned model is created using position information of an object in Nobs past input images. The inference input data is, for example, a floating point vector having the number of grids as a dimension. In this case, the inference input data includes 1 in a case where one or more objects are present in a certain grid, and 0 in a case where no object is present, in an element relevant to the grid. The output (that is, the inference output data) from the learned model is, for example, a floating point vector having the number of grids as a dimension. In this case, the output (that is, the inference output data) from the learned model includes, in an element relevant to a certain grid, a numerical value that increases when it is predicted that the probability that an object is present in the grid is high.

In the first prediction method of the present example embodiment, for example, a predetermined threshold is used, and for each element of the inference output data, in a case where a value is equal to or greater than the threshold, it is predicted that an object exists in the grid relevant to the element. In the first prediction method of the present example embodiment, in a case where the value is less than the threshold, it is predicted that no object is present in the grid relevant to the element. The learned model used by the first prediction method of the present example embodiment is generated, for example, by learning a model for prediction (that is, a prediction model) using the above inference input data and the inference output data generated from a correct answer data set including an image related to a moving object and position information.

The first prediction method of the present example embodiment can use, for example, a deep learning model using a recurrent neural network (RNN) or a long short term memory (LSTM) network. The first prediction method of the present example embodiment can use a deep learning model using a convolutional neural network (CNN) or a transformer by using an input obtained by combining past time series data in a channel direction.

In the first prediction method of the present example embodiment described above, even when a plurality of objects are shown in an image at a certain time, it is possible to predict the future position of the object without identifying, separating, and tracking individual objects. That is, it can be said that the Nobs floating point vectors are independent from each other.

Next, a method of determining the object detection target region by the object detection target region determination unit 20 will be described.

The object detection target region determination unit 20 extracts a grid in which an object exists from a prediction result (that is, information indicating whether objects are located in units of grids) by the object position prediction unit 10. The object detection target region determination unit 20 groups adjacent grids among the extracted grids to create a set of grids. However, the operation of the object detection target region determination unit 20 is not limited thereto. The number of sets of grids is 0, 1, or more according to the position where the object(s) is predicted.

The object detection target region determination unit 20 may set a region relevant to the created set of grids as an individual object detection target region, and may set a set of individual object detection target regions as an object detection target region. The object detection target region determination unit 20 may determine, for each set of created grids, a rectangle having a minimum size including a region relevant to the set, and set the determined rectangle as the individual object detection target region.

The object detection target region determination unit 20 may adjust the individual object detection target region. For example, the object detection target region determination unit 20 may multiply the height and the width of the individual object detection target region by a constant or add a constant value. By enlarging the individual object detection target region, it is possible to avoid overlooking or missing in a case where the prediction is wrong.

For example, the object detection target region determination unit 20 confirms whether the regions overlap for each set of two individual object detection target regions. Then, in the case of overlapping, the object detection target region determination unit 20 may integrate (that is, de-duplicating) the two individual object detection target regions into one individual object detection target region. For example, the object detection target region determination unit 20 may set minimum rectangles including two individual object detection target regions as the integrated individual object detection target region. By integrating (de-duplicating) the individual object detection target regions, it is possible to avoid double detection in object detection for each individual object detection target region. The object detection target region determination unit 20 may perform the adjustment of the individual object detection target region described above after the de-duplicating.

In a case where the object detection result by the second object detection unit 40 is available, the object detection target region determination unit 20 may update the existing object detection target region using the position information of the object detected by the second object detection unit 40. The object detection target region determination unit 20 may newly determine the object detection target region using the position information of the object detected by the second object detection unit 40.

For example, the object detection target region determination unit 20 confirms whether a bounding box of the detected object is included in the object detection target region for each detected object included in the object detection result by the second object detection unit 40. When not included, the object detection target region determination unit 20 may add the bounding box of the detected object as an individual object detection target region and update the object detection target region. At that time, the object detection target region determination unit 20 may adjust and integrate the individual object detection target regions described above. The object detection target region determination unit 20 may handle an object not included in the object detection target region among the detected objects included in the object detection result by the second object detection unit 40 as a new object. In this case, the object detection target region determination unit 20 may store information regarding the new object in the object position storage unit 50. The information regarding the new object may include, for example, information that can identify the new object in addition to position information such as a bounding box.

In a case where the information regarding the new object is stored in the object position storage unit 50, the object detection target region determination unit 20 may update the existing object detection target region using the information regarding the new object. The object detection target region determination unit 20 may newly determine an object detection target region using information regarding a new object.

For each new object, for example, the object detection target region determination unit 20 may add a region relevant to a bounding box of the new object as an individual object detection target region and update the object detection target region. However, the new object may be moving. Therefore, the object detection target region determination unit 20 may set the individual object detection target region after adjusting the bounding box of the new object. For example, the object detection target region determination unit 20 may enlarge the bounding box up, down, left, and right by a predetermined value (that is, adding/subtracting coordinate values). The object detection target region determination unit 20 may adjust and integrate the individual object detection target regions described above.

The object detection target region determination unit 20 may update the information regarding the new object stored in the object position storage unit 50 using the object detection result for the input image input from the image input unit 60. The object detection result is expected to include a detection result at the latest position of the new object.

For example, for each new object, the object detection target region determination unit 20 searches for a detection result relevant to the new object from the object detection results. Then, the object detection target region determination unit 20 may update the information regarding the new object stored in the object position storage unit 50 using the relevant detection result. The object detection target region determination unit 20 can use an arbitrary method as a method of searching for a detection result relevant to a new object from the object detection results. For example, the object detection target region determination unit 20 may calculate an intersection over union (IoU) between a new object and each object included in the object detection result, and an object having the maximum IoU may be relevant to the new object. In a case where the object detection target region determination unit 20 cannot search for a detection result relevant to the new object from the object detection results (for example, in a case where the maximum IoU is less than a predetermined threshold), the object detection target region determination unit may delete the information regarding the new object. The object detection target region determination unit 20 may execute tracking processing on a new object and search for a detection result relevant to the new object from among the object detection results.

The object detection target region determination unit 20 may delete the information regarding the new object stored in the object position storage unit 50 at an arbitrary timing. For example, in a case where the information regarding the new object is sufficiently accumulated to the extent of being used for input to prediction by the object position prediction unit 10, the object detection target region determination unit 20 may delete the information regarding the new object. In a case where the object detection processing by the first object detection unit 30 for the new object is executed Nobs times or more, the object detection target region determination unit 20 may determine that the information is sufficiently accumulated to the extent that the information is used as an input to prediction by the object position prediction unit 10.

### Description of Operation

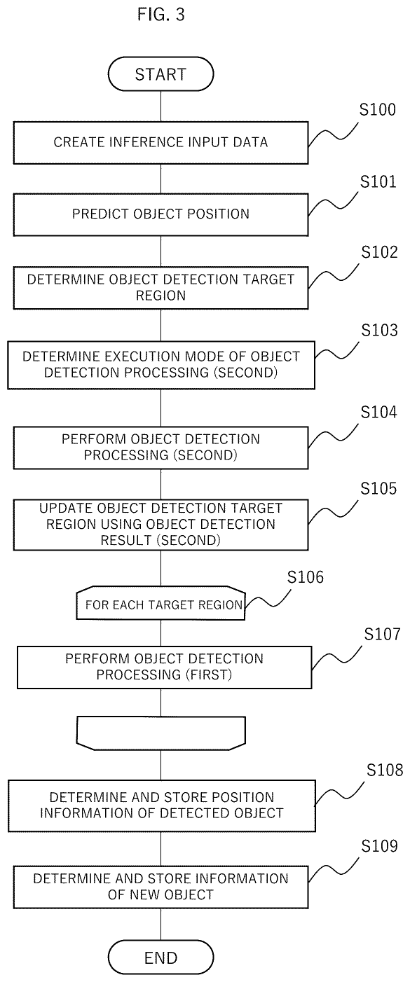

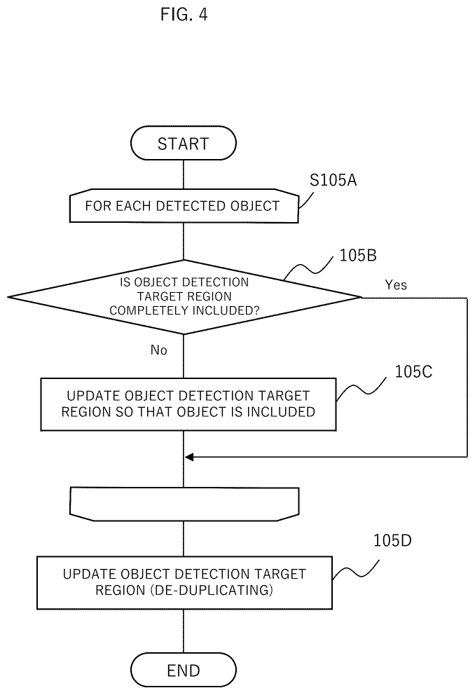

Next, the operation of an image processing device 100 according to the present example embodiment will be described. FIG. 3 and FIG. 4 are flowcharts illustrating the operation of the image processing device.

FIG. 3 and FIG. 4 illustrate an example of the operation of the object detection processing using the first object detection unit 30 and the second object detection unit 40 in combination. This operation includes an operation in which the object detection target region determination unit 20 determines an object detection target region using the object detection result by the second object detection unit 40 in addition to the position information predicted based on the position information of the past detected object (known object) stored in the object position storage unit 50. The present operation includes an operation in which the first object detection unit 30 performs the object detection processing for each individual object detection target region constituting the object detection target region.

For example, the image processing device 1 starts this operation every time an input image is input from the image input unit 60.

The object position prediction unit 10 acquires position information of an object (known object) included in the latest Nobs input images from the object position storage unit 50. The object position prediction unit 10 creates inference input data to be input to prediction-learned model of the first prediction method of the present example embodiment based on the acquired position information (step S100).

Next, the object position prediction unit 10 performs inference by the learned model using the inference input data created in step S100 as an input, and predicts an object position (step S101).

Next, the object detection target region determination unit 20 determines an object detection target region based on the prediction result obtained in step S101 (that is, information indicating whether an object is located in units of grids) (step S102).

Next, the object detection mode determination unit 70 determines an execution mode of object detection by the second object detection unit 40 (step S103). For example, the object detection mode determination unit 70 determines the execution mode of the object detection by the second object detection unit 40 as the mode of the operation examples illustrated in FIG. 2A to FIG. 2E. That is, the object detection mode determination unit 70 determines a mode in which object detection is performed for any of the upper left region, the upper right region, the lower left region, and the lower right region of the input image. The object detection mode determination unit 70 can also determine not to perform object detection as the execution mode of object detection by the second object detection unit 40. In this case, the processing of steps S104 and S105 described later is omitted.

Next, using the input image input from the image input unit 60 as an input, the second object detection unit 40 performs object detection processing in the execution mode determined by the object detection mode determination unit 70 (step S104).

Next, the object detection target region determination unit 20 updates the object detection target region determined in step S102 based on the object detection result obtained in step S104 (step S105). Details of step S105 will be described later.

Next, for each individual object detection target region of the object detection target region obtained in step S105 (step S106), the first object detection unit 30 performs object detection processing on the region in the input image input from the image input unit 60 as a target (step S107). For example, the first object detection unit 30 executes the object detection processing using only the image relevant to the region as an input. The processing of step S107 is repeated until the processing is executed for all the individual object detection target regions. The first object detection unit 30 converts the bounding box information, which is the position information of the object obtained as a result of the object detection processing, from the coordinate value in the individual object detection target region to the coordinate value in the input image input from the image input unit 60.

Next, the first object detection unit 30 stores the position information of the object obtained by the processing of steps S106 and S107 in the object position storage unit 50 (step S108). The first object detection unit 30 may store, in the object position storage unit 50, information for identifying the input image, such as the time when the input image is generated, the identifier of the input image, and the identifier of the image input unit 60, together with the position information of the object. The first object detection unit 30 may store the input image itself in the object position storage unit 50 at the same time.

Next, the object detection target region determination unit 20 stores information (for example, bounding box information) regarding the new object to be processed in step S105C included in step S105 (details will be described later) in the object position storage unit 50 (step S109).

Next, details of step S105 illustrated in FIG. 3 will be described with reference to FIG. 4.

The object detection target region determination unit 20 performs processing of steps S105B and S105C described below for each detected object obtained in step S104 (step S105A).

The object detection target region determination unit 20 confirms whether the bounding box of the detected object is completely included in the object detection target region determined in step S102 (step S105B). In a case where the bounding box is completely included (Yes in step S105B), the object detection target region determination unit 20 ends the processing on the detected object.

In a case where the bounding box is not completely included (No in step S105B), the object detection target region determination unit 20 specifies the detected object as a new object. The object detection target region determination unit 20 updates the object detection target region so that the bounding box of the detected object specified as the new object is completely included (step S105C).

In a case where there are overlapping individual object detection target regions in the object detection target regions updated in steps S105A to S105C, the object detection target region determination unit 20 integrates the regions (step S105D).

The operation examples illustrated in FIG. 3 and FIG. 4 do not limit the operation of the image processing device 1 of the present disclosure. For example, in a case where a new object has been detected in the previous input image, the following processing may be executed in step S109. That is, in step S109, the object detection target region determination unit 20 searches for the new object stored in the object position storage unit 50 and the object having the maximum IoU from the object detection result. Thereafter, the object detection target region determination unit 20 updates the information of the new object using the position information regarding the searched object.

For example, it is assumed that one object is detected as a new object from one input image by the second object detection unit 40, and then the one object is detected as a new object from Nobs input images including the one input image. In this case, the position information regarding the one object is sufficiently accumulated to the extent that the position information is used as an input to prediction by the first prediction method of the present example embodiment. Therefore, the object position prediction unit 10 and the object detection target region determination unit 20 of the image processing device 1 can execute processing with the one object as a known object. At this time, the object detection target region determination unit 20 of the image processing device 1 may delete information regarding the one object stored as a new object in the object position storage unit 50.

### Description of Effects

Next, effects of the present example embodiment will be described. The image processing device 1 according to the first example embodiment can suppress the processing load of the object detection processing. The image processing device 1 according to the first example embodiment can shorten the delay of the object detection processing. The reason is as follows.

The object position prediction unit 10 of the image processing device 1 according to the first example embodiment predicts the position of the object included in the input image. The object detection target region determination unit 20 determines an individual object detection target region which is a partial region of the input image based on the predicted position of the object. The first object detection unit 30 performs object detection processing for each individual object detection target region. The size of the individual object detection target region is expected to be smaller than that of the input image. That is, in the image processing device 1 according to the first example embodiment, the amount of data to be subjected to the object detection processing is reduced, and accordingly, the calculation load is reduced. Therefore, in the image processing device 1, the processing load of the object detection processing can be suppressed. As a result, the throughput of the object detection processing is expected to be improved in the image processing device 1. The delay of the object detection processing is expected to be shortened. That is, in the image processing device 1 according to the first example embodiment, since the period from when the target object appears in the image until the target object is detected is shortened (that is, the delay is shortened), it is possible to quickly respond to the target object.

The second object detection unit 40 of the image processing device 1 performs object detection for the purpose of preventing overlooking of a new object. Then, the object detection target region determination unit 20 determines an individual object detection target region based on the prediction result by the object position prediction unit 10 and the object detection result by the second object detection unit 40 (for example, relevant to the processing of step S105). With such a configuration, the image processing device 1 can cope with not only a known object detected in the past but also a newly appeared new object. With such a configuration, the image processing device 1 can cope with a case where a known object is lost due to a prediction failure.

The image processing device 1 according to the first example embodiment executes the object detection processing by the second object detection unit 40 on the input image in addition to the prediction processing by the object position prediction unit 10 and the object detection processing by the first object detection unit 30. Therefore, the image processing device 1 may increase the processing load of the object detection processing as compared with a configuration in which the object detection processing by the second object detection unit 40 is not executed.

Therefore, the second object detection unit 40 of the image processing device 1 according to the first example embodiment detects an object within a partial region in a new input image. With such a configuration, the image processing device 1 can suppress the processing load as compared with a case where the second object detection unit 40 performs the object detection on the entire region in the new input image.

For example, the second object detection unit 40 can also be configured to intermittently perform object detection on the entire region of the input image for the purpose of preventing overlooking of a new object with respect to a plurality of input images that are continuously input. With such a configuration, the image processing device 1 can suppress the processing load. However, in this case, the processing load increases only with the input image on which the object detection by the second object detection unit 40 is performed among the plurality of input images, and a processing delay may occur.

Therefore, the second object detection unit 40 of the image processing device 1 according to the first example embodiment divides the input image into a plurality of regions, and performs object detection by switching a target region for each input image. With such a configuration, the image processing device 1 can suppress non-uniformity of the processing load on the plurality of input images and distribute the processing delay.

### Variations

For example, the object detection mode determination unit 70 may determine the execution mode of the object detection by the second object detection unit 40 for the new input image based on the object detection result related to the past input image. The object detection result related to the past input image includes, for example, information such as a prediction result by the object position prediction unit 10, an object detection result by the first object detection unit 30, an object detection result by the second object detection unit 40, and a difference between the prediction and the object detection result. The object detection mode determination unit 70 estimates the appearance tendency of a new object based on the object detection result related to the past input image. Then, based on the estimation result, the object detection mode determination unit 70 determines a region, a frequency, accuracy, and the like in which object detection is performed as an execution mode of object detection by the second object detection unit 40. The object detection mode determination unit 70 may determine the type of the learned model used in the object detection as the execution mode of the object detection by the second object detection unit 40.

For example, in most cases in the past input image, when the object moves from the left region to the right region, the object detection mode determination unit 70 estimates that the new object is likely to appear in the left region. For example, in a case where an object hardly appears in the upper region (for example, where the sky is imaged) in the past input image, the object detection mode determination unit 70 estimates that the new object hardly appears in the upper region. Then, for example, the object detection mode determination unit 70 determines the execution mode of the object detection by the second object detection unit 40 so as to perform the object detection at a high frequency in the region where a new object easily appears. For example, the object detection mode determination unit 70 determines the execution mode of object detection by the second object detection unit 40 so as to perform highly accurate object detection in a region where a new object easily appears.

For example, in a case where the new object is a person in most cases in the past input image, the object detection mode determination unit 70 estimates that the new object of the person class is likely to appear. Then, the object detection mode determination unit 70 determines the execution mode of the object detection by the second object detection unit 40 so as to perform the object detection using the learned model specialized in the detection of the person class. For example, in a case where the new object is a vehicle in most cases in the past input image, the object detection mode determination unit 70 estimates that the new object of the vehicle class is likely to appear. Then, the object detection mode determination unit 70 determines the execution mode of the object detection by the second object detection unit 40 so as to perform the object detection using the learned model specialized in the detection of the vehicle class. For example, in a case where the new object detected from the past input image has various types of object classes, the object detection mode determination unit 70 estimates that there is no specific tendency in the object class of the new object. Then, the object detection mode determination unit 70 determines an execution mode of object detection by the second object detection unit 40 so as to perform object detection using a learned model suitable for detection of various types of object classes. The object detection mode determination unit 70 may perform different estimation according to the time zone, the day of the week, the date and time, the season, and the like regarding the estimation described above.

With such a configuration, the image processing device 1 can dynamically adjust parameters of object detection for the purpose of preventing the second object detection unit 40 from overlooking a new object. As a result, the image processing device 1 can suitably execute the object detection by the second object detection unit 40 according to the characteristics and situation of the input image.

The object detection target region determination unit 20 may determine an object detection target region including a prediction region where the object is predicted to be located and a prediction error region relevant to a prediction error. For example, the object detection target region determination unit 20 adds a prediction error region relevant to a prediction error to a prediction region determined based on a prediction result by the object position prediction unit 10, and determines the region as an object detection target region. The prediction error region is, for example, a region around the prediction region. With such a configuration, the image processing device 1 can suppress the possibility of the occurrence of the defect of the object detection even in a case where the prediction by the object position prediction unit 10 is wrong.

For example, the object detection target region determination unit 20 may set the prediction error region for the new input image based on the object detection result related to the past input image. The object detection result related to the past input image includes, for example, information such as a prediction result by the object position prediction unit 10, an object detection result by the first object detection unit 30, an object detection result by the second object detection unit 40, and a difference between the prediction and the object detection result. The object detection target region determination unit 20 estimates the movement tendency of the known object based on the object detection result related to the past input image. Then, the object detection target region determination unit 20 sets the prediction error region based on the estimation result.

For example, in a case where the object moves from the left region to the right region in most cases in the past input image, the object detection mode determination unit 70 sets the prediction error region to be wide on the right side of the prediction region and sets the prediction error region to be narrow on the left side of the prediction region. With such a configuration, the image processing device 1 can dynamically adjust the parameter of the prediction error region relevant to the prediction error. As a result, the image processing device 1 can suitably execute the object detection by the first object detection unit 30 according to the characteristics and situation of the input image.

The image processing device 1 according to the first example embodiment is also applicable to images captured by a plurality of imaging devices having different imaging directions. For example, a vehicle such as an automobile on which a plurality of cameras and laser imaging detection and ranging (LiDAR) are mounted is assumed. In the vehicle, cameras are installed on a front surface, a right side surface, and a left side surface, respectively. In this case, the object imaged by the front camera installed on the front surface is imaged by the side camera installed on the right side surface or the left side surface after a predetermined period. The image processing device 1 can perform image processing by utilizing such a relationship between cameras. Specifically, the image processing device 1 performs prediction by the object position prediction unit 10, object detection by the first object detection unit 30, and object detection for a new object by the second object detection unit 40 on an image captured by the front camera. Then, the image processing device 1 uses the results acquired from the image captured by the front camera for prediction of an object in the image captured by the side camera. That is, the image processing device 1 can calculate the position of the object in the side camera coordinate system from the positional relationship with the front camera and the object position in the image captured by the front camera and use the position as an input of prediction even if the object is not yet shown in the image captured by the side camera.

The image processing device 1 can perform image processing by utilizing information acquired by LiDAR. The information acquired by LiDAR can be used as an object detection result although it is rough. Therefore, instead of executing the object detection by the second object detection unit 40, the image processing device 1 may utilize the information acquired by LiDAR for the purpose of preventing overlooking of a new object. The information acquired by LiDAR includes distance information. Therefore, the image processing device 1 may utilize the information acquired by LiDAR for adjustment of the prediction error region and the like. For example, the image processing device 1 may decrease the prediction error region for a region with a long distance and increase the prediction error region for a region with a short distance. The image processing device 1 may utilize the information acquired by LiDAR for parameter adjustment of the object detection operation. For example, the image processing device 1 may use a lightweight object detection model or a high score threshold for a region where an object appears large. The image processing device 1 may use a highly accurate object detection model or a low score threshold for a region in which an object appears small or a region in which a plurality of objects are close to or overlap with each other. The image processing device 1 can utilize information acquired not only by the LiDAR but also by various other types of sensors. That is, the image processing device 1 can perform the image processing described using the utilization of the camera or the LiDAR as an example by utilizing information acquired by various types of sensors.

The image processing device 1 can perform image processing by utilizing movement information of the vehicle. The movement information of the vehicle includes, for example, a movement speed and a steering angle of the vehicle. The image processing device 1 may adjust various parameters of processing performed by each unit of the image processing device 1 depending on whether the vehicle is moving or stopped. The image processing device 1 may adjust various parameters of processing performed by each unit of the image processing device 1 according to the moving direction of the vehicle. For example, in a state where the vehicle is turning right and moving, the object detection mode determination unit 70 of the image processing device 1 sets the prediction error region to be wide on the right side of the prediction region and sets the prediction error region to be narrow on the left side of the prediction region. The image processing device 1 may switch the learned model used for prediction or the like depending on whether the vehicle is traveling straight or turning. The image processing device 1 may correct the prediction result and the object detection result based on the movement information of the vehicle.

In the above description, an example has been described in which the time interval applied to the input and output to prediction by the object position prediction unit 10 is the same as the generation interval of the input image by the image input unit 60. However, the present disclosure is not limited thereto. Each unit constituting the image processing device 1 including the object position prediction unit 10 and the image input unit 60 may be configured to operate in different time periods. For example, each unit constituting the image processing device 1 may operate using the latest information available at the timing when each unit operates.

The first object detection unit 30 and the second object detection unit 40 may output a score (or configuration or accuracy) for each detected object as an object detection result. Each unit constituting the image processing device 1 may filter the detection result using a predetermined threshold and a score when using the object detection result. The predetermined threshold may be different for each application.

In the above description, the learned model used in the first prediction method of the present example embodiment is generated, for example, by learning a model for prediction (prediction model) using the above inference input data and the inference output data generated from a correct answer data set including an image related to a moving object and position information. However, the present disclosure is not limited thereto. At the time of model learning, conversion, processing, or augmentation may be performed on the correct position information included in the correct answer data set. For example, similarly to the adjustment of the object detection target region, the position of the object may be enlarged vertically and horizontally. In the case of such learning, the prediction result may be larger than the actual object position, but an effect of reducing overlooking of object detection is expected. In the Nobs frames used for one prediction, each object may be translated, laterally or upwardly inverted, rotated, or scaled. The object may be enlarged or reduced in the time direction. That is, the movement speed of the object may be reduced or increased. For example, frames are thinned out one by one from 2·Nobs frames of the correct data to extract the Nobs frames, and these frames may be used as an input of prediction. In this case, the object included in the frame moves at twice the speed.

In the above description, an example has been described in which the object position prediction unit 10 applies the first prediction method of the present example embodiment to all known objects. However, the present disclosure is not limited thereto. The object position prediction unit 10 may apply another prediction method different from the first prediction method of the present example embodiment to some objects. The object position prediction unit 10 may apply, for example, a prediction method involving tracking processing. In general, a prediction method involving tracking processing has a high processing load, but prediction accuracy is improved. Therefore, it is expected that the detection accuracy is improved by using a prediction method involving tracking processing (for example, it is expected that overlooking due to prediction failure is reduced). For example, the object position prediction unit 10 may apply another position prediction method to an object whose score specified as the object detection result is lower than a predetermined threshold. The object position prediction unit 10 may divide the input image into a plurality of regions and apply a different prediction method for each region, or may switch parameters related to prediction for each region. The configuration information and the switching pattern of the region may be given in advance.

In the above description, an example has been described in which both the second object detection unit 40 and the first object detection unit 30 perform the object detection processing in the operation of the object detection processing illustrated in FIG. 3. However, the present disclosure is not limited thereto. For example, in the operation illustrated in FIG. 3, the processing of step S105 and the object detection processing (steps S106 and S107) by the first object detection unit 30 may be omitted. In this case, the object detection result (step S104) by the second object detection unit 40 may be treated as the object detection result by the first object detection unit 30. In step S104, instead of the object detection processing by the second object detection unit 40, the object detection processing by the first object detection unit 30 may be executed on the entire input image.

In the above description, an example has been described in which an input image used as an input to prediction and an input image to be an object detection target (or an input image to be an output target as a prediction result) are input from the same image input unit. However, the present disclosure is not limited thereto. For example, the image processing device 1 may include a plurality of image input units 60 (for example, an image input unit 60A and an image input unit 60B). In this case, the object position prediction unit 10 may predict the future position of the object in the input image input from the image input unit 60B by using the position of the object in the input image input from the image input unit 60A as an input to prediction. The learned model used for inference by the object position prediction unit 10 may be learned assuming such a configuration. The difference in photographing range (or angle of view) between the image input unit 60A and the image input unit 60B may be, for example, fixed. Information indicating a difference in photographing range (or angle of view) between the image input unit 60A and the image input unit 60B may be used at the time of learning.

In the above description, an example in which the image processing device 1 executes the object detection task has been described. However, the present disclosure is not limited thereto. The image processing device 1 may execute other tasks, for example, may execute posture estimation and region recognition (segmentation). For example, the first object detection unit 30 may execute other tasks in addition to or instead of the object detection task. The second object detection unit 40 may execute other tasks in addition to or instead of the object detection task. In a case where the task does not directly generate the position information of the object, the image processing device 1 may generate the position information of the object or the information necessary for the prediction operation by the object position prediction unit 10 as an alternative based on the output from the task. For example, in a case where the task is a posture estimation task, information (type, position, etc.) regarding articulation points of a person in the input image is obtained as an output thereof. The image processing device 1 may generate a person rectangle from the obtained articulation points and use the person rectangle as the position information of the object.

For example, the first object detection unit 30 may execute an image identification task instead of the object detection task. In general, the image identification task has a smaller processing load than the object detection task, and an effect of improving throughput is expected. The first object detection unit 30 may switch whether to use the image identification task according to the characteristics of the individual object detection target region. For example, the first object detection unit 30 may select the image identification task in the following cases.
A case where size of individual object detection target region is predetermined threshold or less
A case where the number of objects existing in the individual object detection target region is expected to be 1 or less
A case where the processing of integration (de-duplicating) is not applied to the individual object detection target region

In the above description, an example has been described in which the image processing device 1 executes the operation of the object detection processing illustrated in FIG. 3 each time an input image is input from the image input unit 60. However, the present disclosure is not limited thereto. For example, in a case where it can be determined in advance that there is no known object and the object detection target region obtained as a result of prediction is empty, the image processing device 1 may omit execution of the operation. As a result, the load related to the prediction is expected to be reduced.

In the above description, an example has been described in which the image input unit 60 generates an input image. However, the present disclosure is not limited thereto. The image input unit 60 may receive compressed image data from an external device and generate an input image by decoding the image data. The image input unit 60 may perform decoding of a compression method such as joint photographic experts group (JPEG) or moving picture experts group (MPEG). The image input unit 60 may switch the generation method using the prediction result for the past input image.

For example, in a case where it can be determined in advance that there is no known object and the object detection target region obtained as a result of prediction is empty, the image input unit 60 may not perform decoding processing or may perform decoding processing using a low-load and low-quality decoding method. The image input unit 60 may perform decoding processing only on a portion of the object detection target region. For example, the image input unit 60 may perform decoding processing for each individual object detection target region, or may perform decoding processing only on a minimum rectangular region including all individual object detection target regions. The image input unit 60 may fill a region not subjected to decoding processing with a dummy image (for example, a black image). The image input unit 60 may output the region information to a component using the input image for the region not subjected to the decoding processing, and cause the component to use the input image by referring to the region information. In a case where it is a timing at which the operation of the object detection processing using the second object detection unit 40 illustrated in FIG. 3 in combination is executed, the image input unit 60 may generate the input image as usual, or may generate the input image using a low-load and low-quality decoding method.

### Hardware Configuration

In the above description, an example has been used in which the object position prediction unit 10, the object detection target region determination unit 20, the first object detection unit 30, the second object detection unit 40, the object position storage unit 50, the image input unit 60, and the object detection mode determination unit 70 are included in the same device (image processing device 1). However, the first example embodiment is not limited thereto.

For example, the image processing device 1 may be configured by connecting devices having functions relevant to the configurations via a predetermined network.

Each component of the image processing device 1 may be configured by hardware circuits. Alternatively, in the image processing device 1, the plurality of components may be configured by one piece of hardware.

Alternatively, the image processing device 1 may be achieved as a computer device including a CPU, a read only memory (ROM), and a random access memory (RAM). In addition to the above configuration, the image processing device 1 may be achieved as a computer device including an input/output connection circuit (IOC). The image processing device 1 may be achieved as a computer device including a network interface card (NIC), in addition to the above configurations.

Alternatively, the image processing device 1 may be achieved as a computer device further including an arithmetic unit that performs calculation for a part or all of processing related to tracking such as feature amount calculation and inference.

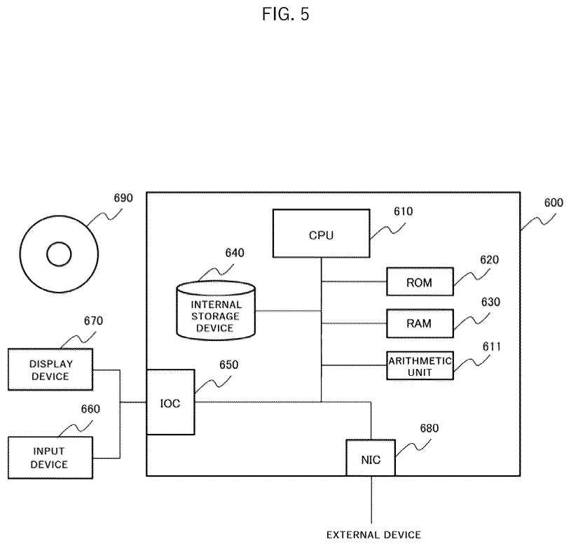

FIG. 5 is a block diagram illustrating a configuration of an information processing device 600 which is an example of a hardware configuration of the image processing device 1.

The information processing device 600 includes a CPU 610, an arithmetic unit 611, a ROM 620, a RAM 630, an internal storage device 640, an IOC 650, and an NIC 680. The information processing device 600 constitutes a computer device.

The CPU 610 reads a program from the ROM 620 and/or the internal storage device 640. The CPU 610 controls the RAM 630, the internal storage device 640, the arithmetic unit 611, the IOC 650, and the NIC 680 based on the read program. The computer device including the CPU 610 controls these configurations and implements the functions of the object position prediction unit 10, the object detection target region determination unit 20, the first object detection unit 30, the second object detection unit 40, and the object position storage unit 50.

When implementing each function, the CPU 610 may use the RAM 630 or the internal storage device 640 as a temporary storage medium of the program.

The CPU 610 may read a program included in a storage medium 690 that stores computer-readable programs, using a storage medium reading device (not illustrated). Alternatively, the CPU 610 may receive a program from an external device (not illustrated) via the NIC 680, store the program in the RAM 630 or the internal storage device 640, and operate based on the stored program.

The arithmetic unit 611 may be, for example, any of a graphics processing unit (GPU), a field programmable gate array (FPGA), an application specific integrated circuit (ASIC), or an artificial intelligence (AI) chip. For example, the arithmetic unit 611 may perform calculation for a part or all of processing such as object detection and prediction inference under the control of a program executed by the CPU 610. Data, programs, circuit information, and the like necessary for the calculation by the arithmetic unit 611 may be stored in, for example, the ROM 620, the RAM 630, the internal storage device 640, and the like.

The ROM 620 stores the programs executed by the CPU 610 and fixed data. The ROM 620 is, for example, a programmable ROM (P-ROM) or a flash ROM.

The RAM 630 temporarily stores the program executed by the CPU 610 and data. The RAM 630 is, for example, a dynamic RAM (D-RAM).

The internal storage device 640 stores the data and programs to be stored for a long time by the information processing device 600. The internal storage device 640 may operate as the object position storage unit 50. The internal storage device 640 may operate as a temporary storage device of the CPU 610. The internal storage device 640 is, for example, a hard disk device, a magneto-optical disk device, a solid state drive (SSD), or a disk array device.

The ROM 620 and the internal storage device 640 are non-transitory recording media. On the other hand, the RAM 630 is a transitory recording medium. The CPU 610 can operate based on the program stored in the ROM 620, the internal storage device 640, or the RAM 630. That is, the CPU 610 can operate using a non-transitory recording medium or a transitory recording medium.

The IOC 650 mediates data between the CPU 610 and an input device 660 and a display device 670. The IOC 650 is, for example, an IO interface card or a universal serial bus (USB) card. Furthermore, the IOC 650 is not limited to wired connection such as USB, and may be wirelessly connectable.

The input device 660 is a device that receives an instruction from an operator of the information processing device 600. For example, the input device 660 receives a parameter. The input device 660 is, for example, a keyboard, a mouse, or a touch panel. The input device 660 may be an input device that functions as the image input unit 60. The image input unit 60 may be, for example, a camera device.

The display device 670 is a device capable of displaying information to an operator of the information processing device 600. The display device 670 is, for example, a liquid crystal display, an organic electroluminescence display, or electronic paper.

The NIC 680 relays exchange of data with an external device (not illustrated) via the network. The NIC 680 is, for example, a local area network (LAN) card. The NIC 680 is not limited to a wired one, and may be wirelessly connectable to an external device.

The information processing device 600 configured as described above can obtain effects similar to those of the image processing device 1. This is because the CPU 610 of the information processing device 600 can achieve the same functions as those of the image processing device 1 based on the program. This is because the CPU 610 and the arithmetic unit 611 of the information processing device 600 can achieve the same functions as those of the image processing device 1 based on the program.

### Second Example Embodiment

Next, a second example embodiment of the present disclosure will be described. An image processing device 1B according to the second example embodiment generates an aggregate image obtained by collecting image regions of an object detection target region, and performs object detection on the aggregate image as a target.

The second example embodiment will be described with reference to the drawings. The drawings referred to in the description of the second example embodiment are denoted by the same reference numerals as those of the first example embodiment with respect to the configuration performing the same operation as that of the first example embodiment. Detailed description of these configurations is omitted.

### Description of Configuration

A configuration of an image processing device 1B according to the second example embodiment will be described with reference to the drawings. The image processing device 1B may be configured using a computer device as illustrated in FIG. 5, similarly to the first example embodiment.

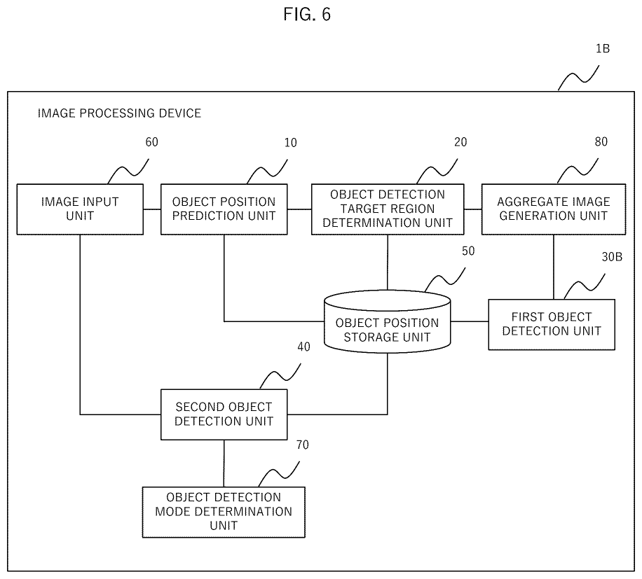

FIG. 6 is a block diagram illustrating an example of a configuration of the image processing device 1B according to the present disclosure.

The image processing device 1B illustrated in FIG. 6 includes an object position prediction unit 10, an object detection target region determination unit 20, a first object detection unit 30B, a second object detection unit 40, an object position storage unit 50, an image input unit 60, an object detection mode determination unit 70, and an aggregate image generation unit 80.

The aggregate image generation unit 80 generates an aggregate image obtained by collecting image regions of the object detection target region. The aggregate image generation unit 80 receives the information indicating the object detection target region from the object detection target region determination unit 20, and generates an image (aggregate image) obtained by collecting the image regions of the individual object detection target regions. Collecting (that is, copying) the obtained image regions is referred to as Packing. The aggregate image generation unit 80 may generate one or a plurality of aggregate images. When generating the aggregate image, the aggregate image generation unit 80 stores the individual object detection target region and the information indicating the arrangement of the individual object detection target region on the aggregate image in the storage unit in association with each other. When performing Packing, the aggregate image generation unit 80 may provide a gap (interval) having a predetermined width between the image regions.

When performing Packing, the aggregate image generation unit 80 may change (that is, enlarge or reduce) the size of the individual object detection target region and copy the individual object detection target region to the aggregate image. In the case of reducing the size, since the number of aggregate images is reduced, there is a possibility that the inference processing time for object detection can be shortened. In the case of increasing the size, there is a possibility that the recognition accuracy can be improved. The aggregate image generation unit 80 may determine whether to change the size of the individual object detection target region or determine the size after the change based on a threshold or the like given in advance. For example, the aggregate image generation unit 80 may determine whether to change the size of the individual object detection target region or determine the size after the change based on the area of the individual object detection target region. The aggregate image generation unit 80 may perform image processing such as complementary processing when changing the size of the individual object detection target region. The aggregate image generation unit 80 may perform arbitrary image processing in addition to changing the size of the image region or instead of changing the size of the image region. The aggregate image generation unit 80 may perform, for example, brightness adjustment, luminance adjustment, color adjustment, contrast adjustment, geometric correction, and the like as the image processing.

The first object detection unit 30B has a function similar to that of the first object detection unit 30 of the first example embodiment. However, the first object detection unit 30B uses the aggregate image generated by the aggregate image generation unit 80 as an input instead of using the image of the individual object detection target region as an input.

### Description of Operation

Next, an example of an operation in the image processing device 1B according to the second example embodiment will be described with reference to the drawings. In the operations (steps) in the image processing device 1B according to the second example embodiment, the same step numbers are assigned to the same operations (steps) as those of the image processing device 1 according to the first example embodiment. Detailed description of these operations (steps) will be omitted.

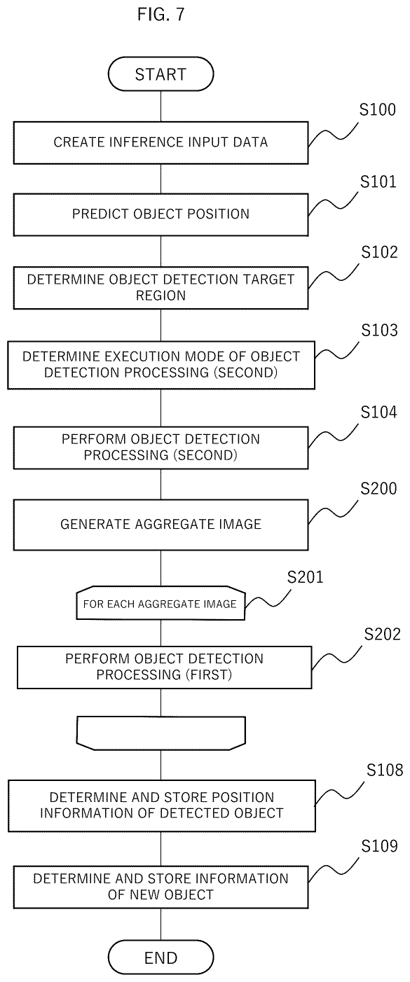

FIG. 7 is a flowchart illustrating an example of the operation of the object detection processing in the image processing device 1B according to the present disclosure.

The image processing device 1B performs processing of steps S100 to S105.

Next, the aggregate image generation unit 80 generates an aggregate image based on the object detection target region obtained in step S105 (step S200).

Next, for each of the aggregate images generated in step S200 (step S201), the first object detection unit 30B performs object detection processing on the aggregate images (step S202). For example, the first object detection unit 30B executes the object detection processing using the aggregate image as an input. The first object detection unit 30B converts the bounding box information, which is the position information of the object obtained as a result of the object detection processing, from the coordinate values in the aggregate image to the coordinate values in the input image input from the image input unit 60. The processing of step S202 is repeated until all the generated aggregate images are executed.

### Description of Effects

Next, effects of the second example embodiment will be described.

The image processing device 1B according to the second example embodiment can suppress the processing load of the object detection processing similarly to the first example embodiment. The image processing device 1B according to the second example embodiment can shorten the delay of the object detection processing.

The image processing device 1B generates an aggregate image based on the individual object detection target region. Next, the image processing device 1B performs object detection for each of the generated aggregate images. The size of the aggregate image is expected to be smaller than that of the input image. Therefore, in the image processing device 1B according to the second example embodiment, the target amount of data of the object detection processing is reduced, and accordingly, the calculation load is reduced. Therefore, in the image processing device 1B, the processing load of the object detection processing can be suppressed. As a result, the throughput of the object detection processing is expected to be improved in the image processing device 1B. The delay of the object detection processing is expected to be shortened. That is, in the image processing device 1B according to the second example embodiment, since the period from when the target object appears in the image until the target object is detected is shortened (that is, the delay is shortened), it is possible to quickly respond to the target object.

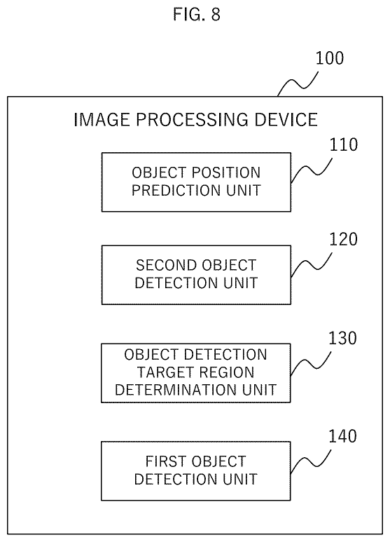

Next, an outline of the present disclosure will be described. FIG. 8 is a block diagram illustrating an outline of an image processing device according to the present disclosure. An image processing device 100 (in the example embodiment, the image processing device 1 or the image processing device 1B) illustrated in FIG. 8 includes an object position prediction unit 110 (in the example embodiment, it is achieved by the object position prediction unit 10) for predicting a position of an object in a new input image based on a position of the object detected in a past input image, a second object detection unit 120 (in the example embodiment, it is achieved by the second object detection unit 40) for performing object detection within a partial region in the new input image, an object detection target region determination unit 130 (in the example embodiment, it is achieved by the object detection target region determination unit 20) for determining an object detection target region to be an object detection target in the new input image based on a prediction result by the object position prediction unit 110 and an object detection result by the second object detection unit 120, and a first object detection unit 140 (in the example embodiment, it is achieved by the first object detection unit 30 or the first object detection unit 30B) for performing object detection for the object detection target region determined by the object detection target region determination unit 130. With such a configuration, in the image processing device 100, the processing load of the object detection processing can be suppressed.

While the present disclosure has been particularly shown and described with reference to example embodiments thereof, the present disclosure is not limited to the example embodiments described above. Various modifications that can be understood by those of ordinary skill in the art can be made to the configuration and details of the present disclosure within the scope of the present disclosure. Each example embodiment can be appropriately combined with another example embodiment.

Each of the drawings is merely an example to illustrate one or more example embodiments. Each of the drawings is not associated with only one specific example embodiment, but may be associated with one or more other example embodiments. As those skilled in the art will appreciate, various features or steps described with reference to any one of the drawings may be combined with features or steps illustrated in one or more other drawings, for example, to create an example embodiment that is not explicitly illustrated or described. All of the features or steps illustrated in any one of the drawings for describing exemplary embodiments are not necessarily mandatory, and some features or steps may be omitted. The order of the steps described in any of the drawings may be changed as appropriate.

Some or all of the above-described example embodiments may be described as the following supplementary notes, but are not limited to the following supplementary notes.

### Supplementary Note 1

An image processing device including:
an object position prediction unit for predicting a position of an object in a new input image based on a position of the object detected in a past input image;
a second object detection unit for performing object detection on a partial region in a new input image;
an object detection target region determination unit for determining an object detection target region to be an object detection target in a new input image based on a prediction result by the object position prediction unit and an object detection result by the second object detection unit; and
a first object detection unit for performing object detection for the object detection target region determined by the object detection target region determination unit.

### Supplementary Note 2

The image processing device according to Supplementary Note 1, in which the second object detection unit divides an input image into a plurality of regions, and performs object detection by switching a target region for each input image.

### Supplementary Note 3

The image processing device according to Supplementary Note 1 or 2, in which the second object detection unit performs object detection using a learned model lighter than a learned model used by the first object detection unit.

### Supplementary Note 4

The image processing device according to any one of Supplementary Notes 1 to 3, in which the second object detection unit intermittently performs object detection with respect to a plurality of input images continuously input.

### Supplementary Note 5

The image processing device according to any one of Supplementary Notes 1 to 4, including an object detection mode determination unit for determining an execution mode for object detection by the second object detection unit,
in which the second object detection unit performs object detection based on a determination result of the object detection mode determination unit.

### Supplementary Note 6

The image processing device according to Supplementary Note 5, in which the object detection mode determination unit determines an execution mode for object detection by the second object detection unit for a new input image based on an object detection result related to a past input image.

### Supplementary Note 7

The image processing device according to any one of Supplementary Notes 1 to 6, in which the object detection target region determination unit determines the object detection target region including a prediction region in which an object is predicted to be located and a prediction error region relevant to a prediction error.

### Supplementary Note 8

The image processing device according to Supplementary Note 7, in which the object detection target region determination unit sets the prediction error region for a new input image based on an object detection result related to a past input image.

### Supplementary Note 9

An image processing method causing a computer to execute:
predicting a position of an object in a new input image based on a position of the object detected in a past input image;
performing second object detection within a partial region in a new input image;
determining an object detection target region to be an object detection target in a new input image based on a prediction result and a second object detection result; and
performing first object detection within the object detection target region.

### Supplementary Note 10

An image processing program that, when executed by a computer, performs:
predicting a position of an object in a new input image based on a position of the object detected in a past input image;
performing second object detection within a partial region in a new input image;
determining an object detection target region to be an object detection target in a new input image based on a prediction result by the predicting of the position and an object detection result by the performing of second object detection; and
performing first object detection within the object detection target region.

### Supplementary Note 11

A non-transitory computer-readable recording medium storing an image processing program that, when executed by a computer, performs operations comprising:
predicting a position of an object in a new input image based on a position of the object detected in a past input image;
performing second object detection within a partial region in a new input image;
determining an object detection target region to be an object detection target in a new input image based on a prediction result by the predicting of the position and an object detection result by the performing of second object detection; and
performing first object detection within the object detection target region.

Some or all of the elements (for example, configurations and functions) described in Supplementary Notes 2 to 8 depending from Supplementary Note 1 may depend from Supplementary Notes 9, 10, and 11 as well with depending relationships similar to those of Supplementary Notes 2 to 8. Some or all of the elements described in any Supplementary Note may be applied to various types of hardware, software, recording means for recording software, systems, and methods.

1. An image processing device comprising:
a memory configured to store software instructions; and
one or more processors configured to execute the software instructions to:
predict a position of an object in a new input image based on a position of the object detected in a past input image;
perform second object detection within a partial region in the new input image;
determine an object detection target region to be an object detection target in the new input image based on a prediction result and a second object detection result; and
perform first object detection within the object detection target region.

2. The image processing device according to claim 1, wherein
the one or more processors divide an input image into a plurality of regions, and perform second object detection by switching a target region for each input image.

3. The image processing device according to claim 1, wherein
the one or more processors perform second object detection using a learned model lighter than a learned model used to perform first object detection within the object detection target region.

4. The image processing device according to claim 1, wherein
the one or more processors intermittently perform second object detection with respect to a plurality of input images continuously input.

5. The image processing device according to claim 1, wherein the one or more processors are further configured to execute the software instructions to:
determine an execution mode for second object detection,
wherein the one or more processors perform second object detection based on a determined execution mode.

6. The image processing device according to claim 5, wherein
the one or more processors determine an execution mode for second object detection on the new input image based on an object detection result related to the past input image.

7. The image processing device according to claim 1, wherein
the one or more processors determine the object detection target region including a prediction region in which an object is predicted to be located and a prediction error region relevant to a prediction error.

8. The image processing device according to claim 7, wherein
the one or more processors set the prediction error region for the new input image based on an object detection result related to the past input image.

9. An image processing method performed by a computer and comprising:
predicting a position of an object in a new input image based on a position of the object detected in a past input image;
performing second object detection within a partial region in the new input image;
determining an object detection target region to be an object detection target in the new input image based on a prediction result and a second object detection result; and
performing first object detection within the object detection target region.

10. A non-transitory computer-readable recording medium storing an image processing program that, when executed by a computer, performs operations comprising:
predicting a position of an object in a new input image based on a position of the object detected in a past input image;
performing second object detection within a partial region in the new input image;
determining an object detection target region to be an object detection target in the new input image based on a prediction result and a second object detection result; and
performing first object detection within the object detection target region.

11. The image processing device according to claim 2, wherein
the one or more processors perform second object detection using a learned model lighter than a learned model used to perform first object detection within the object detection target region.

12. The image processing device according to claim 2, wherein
the one or more processors intermittently perform second object detection with respect to a plurality of input images continuously input.

13. The image processing device according to claim 2, wherein the one or more processors are further configured to execute the software instructions to:
determine an execution mode for second object detection,
wherein the one or more processors perform second object detection based on a determined execution mode.

14. The image processing device according to claim 13, wherein
the one or more processors determine an execution mode for second object detection on the new input image based on an object detection result related to the past input image.

15. The image processing device according to claim 2 wherein
the one or more processors determine the object detection target region including a prediction region in which an object is predicted to be located and a prediction error region relevant to a prediction error.

16. The image processing device according to claim 15, wherein
the one or more processors set the prediction error region for the new input image based on an object detection result related to the past input image.
